(19) United States
(12) Patent Application Publication
(10) Pub. No.: US 2023/0059151 A1
(43) Pub. Date: Feb. 23, 2023

(54) CERAMIC MATRIX COMPOSITES ENABLE THROUGH METAL HALIDE ASSISTED SINTERING

(71) Applicant: THE RESEARCH FOUNDATION FOR THE STATE UNIVERSITY OF NEW YORK, Albany, NY (US)

(72) Inventors: Lance SNEAD, Stony Brook, NY (US); David SPROUSTER, Port Jefferson, NY (US); Jason TRELEWICZ, Stony Brook (US)

(73) Assignee: THE RESEARCH FOUNDATION FOR THE STATE UNIVERSITY OF NEW YORK, Albany, NY (US)

(21) Appl. No.: 17/790,086

(22) PCT Filed: Jan. 21, 2021
(86) PCT No.: PCT/US2021/014296

§ 371 Date: Jun. 29, 2022

Related U.S. Application Data
(60) Provisional application No. 62/964,420, filed on Jan. 22, 2020.

(51) Int. Cl. G21C 3/64; G21C 21/02

(52) U.S. Cl. CPC G21C 3/64; G21C 21/02

(57) ABSTRACT

Composite structures are provided whose composite matrix is a fully-dense (greater than 95%) magnesium oxide-containing phase and whose entrained phase, by virtue of its' decomposition temperature or chemical reactivity, would otherwise not be fabricable. Notably, a methodology is provided whereby a range of composite structures are formed by applying an advanced manufacturing technique and a blend of ceramic powder whose sintering is enhanced by small amounts of a metal halide sintering aid. This methodology and process significantly lowers the processing temperature of refractory ceramics such as magnesium oxide allowing formation of ceramic bodies incorporating phases such as metal hydrides, fragile ceramic phases, and highly reactive species such as beryllides. In all cases, the final product is substantially-free, or even devoid, of the metal halide sintering aid, resulting in a phase-pure ceramic matrix composed of the host phase and the entrained phase.

### CROSS REFERENCE TO RELATED APPLICATION

The present invention claims the benefit of U.S. Provisional Patent Application No. 62/964,420, filed Jan. 22, 2020, the entire content and disclosure of which is incorporated herein by reference.

### GOVERNMENT SUPPORT

This invention was made with government support under DE-AR00009777 awarded by the Department of Energy. The government has certain rights in the invention.

### TECHNICAL FIELD

The present invention relates to ceramic matrix compositions (i.e., composite structures) which by virtue of specific processing steps results in a near-full-density (greater than 95%) magnesium oxide (MgO)-containing host matrix including one or more relatively low-temperature and/or fragile phrases contained within that host matrix.

### BACKGROUND

The production of monolithic magnesium oxide (MgO, also referred to as magnesia) ceramic bodies is an established technology with commercial and research products widely available. Given its low cost and physical and chemical stability at high temperature, magnesia is widely used in the refractory industry with a wide range of other uses. Magnesia, as with a range of other commercially important ceramics, can be formed through a range of processing methods of which sintering is the most common. In magnesia's ceramic form, various industrial applications may utilize relatively low-density ceramic bodies (less than 90%) while applications which require relatively strong or thermally conductive bodies choose dense ceramics (greater than 90%). Here the ceramic of interest and prior-art being discussed relates to composite structures of fully dense magnesia matrix (greater than 95%) or matrices near (greater than 99%) the theoretical density of magnesia.

Processes for commercial magnesia production, as typical of ceramic bodies, include hot-pressing, hot isostatic pressing and pressure-less sintering, electrically-assisted sintering, and slip casting. Temperature well in excess of 1300° C. and the use of sintering aids is typically required to achieve a high-density product; See, for example, U.S. Patent No. 4,678,761 to Virkar et al. Sintering of MgO powder (typically of high purity and tens to hundreds of microns in diameter) requires temperature well in excess of 1400° C. to achieve full-density in the absence of large applied pressure, where greater pressure can reduce processing temperatures to about 1300° C. The calcination temperature and rate of calcination has been shown to impact the final sintering temperature of the MgO starting powder. In one example of consolidating pure MgO powders, a near theoretical density ceramic is achieved without degradation in thermomechanical properties by applying a pressure-less sintering step at 1400° C. followed by two uniaxial hot-pressing steps at 20 MPa, 1500° C. and 100 MPa, 1400-1600° C. (See, U.S. Pat. No. 8,454,933 to Nagano et al.). Addition of sintering aids may further suppress sintering temperature for which full density is achieved to approximately 1200-1300° C. Typical sintering aids promoting the densification of magnesia ceramic include a range of metallic (such as, for example, Al, Cr, Fe, Li, and Mn) and oxide additives (such as, for example, TiO₂, Al₂O₃, SIO₂, and FeO₂). A range of Li-bearing materials in the classic sintering of MgO has been investigated, resulting in a reduction of sintering temperature to 1300-1400° C. reporting porosity for a number of powder types in the range of 6-50%.

Sintering pressures and temperatures are also a function of the particle size and magnesia powder purity. Nano-powder MgO, having diameters ranging from a few tens to several tens of microns, have been shown to yield greater ceramic density following both pressure-less sintering, hot-pressing, and electrically-assisted sintering. As an example, optically translucent MgO and dense ceramic has been produced through hot-pressing of MgO nano-powder with addition of LiF sintering aid at 45 MPa and 1000-1100° C.; See, for example, Fang et al., Materials Letters, Volume 58, Issue 5, February 2004, pages 551-554. A similar work employing electrically-assisted sintering of approximately 60 nm nano-powder MgO resulted in MgO having a density of greater than 95%.

Composite structures, for which magnesia is the matrix (host) phase, have been considered for many applications, taking advantage of the refractory nature of MgO and its low cost. For example, magnesia-based refractory brick, which incorporates second phase materials as Mg₂SiO₄ and Mg(Al_{1.5}Cr_{0.5})O₄(magnesia-chromite) or carbon (magnesia-carbon) and used as furnace materials in a wide range of metal processing due to their excellent resistance to oxidation and resistance to spalling, is known. MgO/AlN ceramic composites have attracted interest in the steel industry due to the superior resistance of MgO to slag and the improved thermal conductivity. Higher value composite structures such as continuous and chopped fibers of magnesia within metal, carbon, or ceramic matrices (including magnesia) have been considered for structural application, though have attracted little commercial or academic interest.

The vast majority of commercial fission power reactors in the world are defined as “Thermal-neutron Reactors” insofar as the fission process of Uranium-235 and Plutonium-239 is triggered by the absorption of a thermal (low energy) neutron. This thermal neutron begins life as a very high-energy neutron (greater than 1 MeV) emanating directly from the fission reaction and then down-graded in energy, or moderated, through billiard-ball collisions within the reactor. For light-water reactors (the current fleet of power reactors) the moderation primarily occurs through collisions with the hydrogen in the water molecule. For gas-cooled-reactors (historically the first fission reactor) the moderation primarily occurs through collisions with the graphite (carbon) blocks making up the reactor core structure. Physically the most effective moderating materials include low atomic numbered constituent atoms which do not simultaneously absorb significant neutrons: H:Be:Li:C:O:Mg:Al:Si, etc.

The current direction for nuclear power research is to both reduce the physical size and power output of thermal reactors. This development is towards the realization of so-called “small modular reactors”. In order to produce efficient and compact small modular reactors the use of advanced moderating materials containing magnesia as the matrix (host) phase is now being considered. The potential for realizing high-performance magnesia-based composites may be greatly improved by simultaneously reducing the temperature and pressure required to form fully dense magnesia matrices, as example with processing temperatures less than 1000° C. and pressures less than tens of MPa.

The ability to form dense multiphase, or functional ceramic composites is typically limited to materials with similar processing parameters of temperature, stress, and environment. Ceramics, which are typically sintered at relatively high pressure and temperature are challenging host matrices for composite bodies incorporating relatively low-temperature and/or fragile constituents.

### SUMMARY

The present invention provides composite structures whose composite matrix is a fully-dense (greater than 95%) magnesium oxide-containing phase and whose entrained phase, by virtue of its' decomposition temperature or chemical reactivity, would otherwise not be fabricable. Notably, a methodology is provided whereby a range of composite structures are formed by applying an advanced manufacturing technique and a blend of ceramic powder whose sintering is enhanced by small amounts of a metal halide sintering aid. This methodology and process significantly reduces the processing temperature of refractory ceramics such as magnesium oxide allowing formation of ceramic bodies incorporating phases such as metal hydrides, fragile ceramic phases, and highly reactive species such as beryllides. In all cases, the final product is substantially-free, or even devoid, of the metal halide sintering aid or its disassociation or reaction products, resulting in a phase-pure ceramic matrix composed of the host phase and the entrained phase. By “substantially-free of the metal halide sintering aid or its disassociation or reaction products”, it is meant that the composite structures of the present invention contain less than 100 ppm of the metal halide sintering aid or its disassociation or reaction products.

In one embodiment of the present invention, a composite structure including a beryllium-containing phase contained within a magnesium oxide-containing matrix having a density of greater than 95% is provided. Such a composite structure is processed at temperatures at or below 1000° C.

In another embodiment of the present invention, a composite structure including a metal hydride-containing phase contained within a magnesium oxide-containing matrix having a density of greater than 95%, wherein the metal of the metal hydride-containing phase is selected from yttrium, zirconium, lithium and mixtures thereof, is provided.

In a further embodiment of the present invention, a composite structure including a microencapsulated nuclear fuel contained within a magnesium oxide-containing matrix having a density of greater than 95% is provided.

In a yet further embodiment of the present invention, a fission reactor including core structural components as a composite of a beryllium-containing phase or a metal hydride-containing phase contained within a magnesium oxide-containing matrix having a density of greater than 95% , wherein the metal of the metal hydride is selected from yttrium, zirconium, lithium and mixtures thereof, is provided. The composite is used to slow neutrons to an energy appropriate for nuclear fission through elastic collisions.

In yet another embodiment of the present invention, a fission reactor including a nuclear fuel is provided. In this embodiment, the nuclear fuel is composed of a microencapsulated nuclear fuel contained within a magnesium oxide-containing matrix having a density of greater than 95%.

In still yet another embodiment of the present invention, a method of forming a composite structure as defined in any of the embodiments mentioned above is provided. In one embodiment, the method includes forming a green body of a magnesium oxide-containing powder, a metal halide sintering aid, and an entrainment compound selected from a beryllium-containing compound, a metal hydride-containing compound, wherein the metal of the metal hydride-containing phase is selected from yttrium, zirconium, lithium and mixtures thereof, a microencapsulated nuclear fuel, and a mixture thereof. The green body is then sintered utilizing an electrically-assisted sintering process to provide a composite structure including an entrained phase including at least one of the entrainment compounds contained within a magnesium oxide-containing matrix having a density of greater than 95%. In accordance with the present invention, the metal halide sintering aid that is employed has a bulk or eutectic melting temperature that is substantially the same as the sintering temperature of the entrainment compound.

### BRIEF DESCRIPTION OF THE DRAWINGS

FIG. 1A is a graph illustrating both the displacement and temperature (in ° C.) vs. time (in minutes) for a composite structure including beryllium (Be) metal entrained within a fully dense (greater than 95%) MgO matrix made using a metal chloride assisted sintering process in accordance with the present invention.

FIG. 1B is a graph illustrating the displacement vs. sintering temperature (in ° C.) for a composite structure including Be metal entrained within a fully dense (greater than 95%) MgO matrix made using a metal chloride assisted sintering process in accordance with the present invention, and a composite structure made without the metal chloride.

FIG. 1C is a graph of MgO matrix density (in %) vs. sintering temperature (in ° C.) for a composite structure including Be metal entrained within a fully dense (greater than 95%) MgO matrix made using a metal chloride assisted sintering process in accordance with the present invention and made using different sintering pressures.

FIG. 2 is a tomographic X-ray image of a composite structure containing beryllium (Be)-metal nodules entrained within a near theoretical dense MgO matrix in accordance with an embodiment of the present invention.

FIG. 3 is a tomographic X-ray image of a composite structure containing yttrium hydride (YH₂₋ₓ) entrained within a near theoretical dense MgO matrix in accordance with another embodiment of the present invention.

FIG. 4 is a tomographic X-ray image of a composite structure containing a microencapsulated bi-structural isotropic (BISO) fuel entrained within a near theoretical dense MgO matrix in accordance with a further embodiment of the present invention.

FIG. 5 is a tomographic X-ray image of a composite structure containing a microencapsulated tri-structural isotropic (TRISO) fuel entrained within a near theoretical dense MgO matrix in accordance with a further embodiment of the present invention.

### DETAILED DESCRIPTION

The present invention will now be described in greater detail by referring to the following discussion and drawings that accompany the present invention. It is noted that the drawings of the present invention are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present invention. However, it will be appreciated by one of ordinary skill in the art that the various embodiments of the present invention may be practiced without these specific details. In other instances, well-known structures or processing steps have not been described in detail in order to avoid obscuring the present invention.

It will be understood that when an element as a layer, region or substrate is referred to as being “on” or “over” another element, it can be directly on the other element or intervening elements may also be present. In contrast, when an element is referred to as being “directly on” or “directly over” another element, there are no intervening elements present. It will also be understood that when an element is referred to as being “beneath” or “under” another element, it can be directly beneath or under the other element, or intervening elements may be present. In contrast, when an element is referred to as being “directly beneath” or “directly under” another element, there are no intervening elements present. The term “about” when used in conjunction with a numerical value means that the numerical value can vary within±10% of the numerical value.

The present invention provides two-phase composite structures including an entrained (i.e., second) phase (to be described in greater detail herein below) contained within a magnesium oxide-containing matrix (i.e., host phase) having a density of greater than 95%. Both the entrained phase and the magnesium oxide-containing matrix of the composite structures of the present invention are solid materials. The composite structures of the present invention are substantially-free, or even devoid, of any metal halide sintering aid which is used in fabricating the composite structure. In some embodiments of the present invention, the magnesium oxide-containing matrix can have a density of greater than 96%, greater than 97%, greater than 98% and greater than 99%. In some embodiments of the present invention, the magnesium oxide-containing matrix is composed of MgO (i.e., magnesia). In other embodiments of the present invention, the magnesium oxide-containing matrix is composed of MgAl₂O₄. A primary motivation for having a fully dense magnesia matrix is to provide a rigid structure for the entrained phase which is devoid of interconnected porosity thereby limiting any migration of chemical species through or out of the composite structure.

Composite Structure 1:

In some embodiments of the present invention, the entrained phase that is contained within the magnesium oxide-containing matrix is a beryllium-containing phase; such a composite structure is referred to herein as Composite Structure 1. Due to its stiffness, low density, and dimensional stability at low to intermediate temperatures, beryllium (Be) finds a wide array of aerospace structural applications. Additionally, due to its unique and favorable optical properties, beryllium can be used in terrestrial and satellite mirrors. Solid beryllium also finds substantial use in the nuclear industry in weapon design and neutron sources, and through beryllium's high efficiency in slowing down neutrons through elastic collision, combined with beryllium's low cross section absorbing those same neutrons, beryllium has been extensively used as a “neutron moderator” in fission reactors. However, the use of beryllium has become increasingly difficult and expensive due to its toxicity, relatively low useful temperature, and poor mechanical properties when subjected to irradiation. Beryllium metal melts at 1287° C., softening considerably at about half its melting point, and reacts with MgO in the 700-800° C. range. The oxide of magnesia is preferred such that formation of BeO is relatively slow.

In nuclear applications where beryllium components are exposed to significant fluxes of fast neutrons, beryllium undergoes serious property degradation for all temperature ranges it could be considered as structurally sound. At low irradiation temperature, beryllium is embrittled through crystalline defect damage caused by neutron collisions with the beryllium atoms. At intermediate and high temperature, a neutronic reaction in which a neutron is absorbed causes beryllium transformation into the atoms of lithium and helium. In this case, the resulting beryllium microstructure becomes significantly embrittled and for application temperature more than half beryllium's melting temperature irradiation-induced swelling becomes appreciable. For these reasons, along with its inherent toxicity, the use of beryllium in nuclear applications is now limited.

The formation of composite structures composed a magnesium oxide-containing matrix having a density of greater than 95% and a continuum of entrained beryllium-containing phase combines the advantages of each material while mitigating certain negative aspects of beryllium: as the magnesium oxide crystal is relatively irradiation-stable, composite structures formed may exhibit superior performance under fast neutron irradiation. Moreover, concerns with regards to handling the beryllium-containing material are lessened as it is encased within a structurally and thermally stable magnesium oxide-containing matrix.

In Composite Structure 1 of the present invention in which a beryllium-containing phase is contained within the fully dense magnesium oxide-containing matrix, the beryllium-containing phase can present in the magnesium oxide-containing matrix in an amount from about 10 volume % to about 50 volume %, with an amount from 15 volume % to about 40 volume % being more preferred. In some embodiments, the beryllium-containing phase is distributed randomly in the magnesium oxide-containing matrix. In yet other embodiments, the beryllium-containing phase is distributed in an ordered manner in the magnesium oxide-containing matrix.

The beryllium-containing phase is composed of a beryllium-containing solid material that typically has a shape of a nodule. In one embodiment of the present invention, the beryllium-containing phase is composed entirely of beryllium metal. In another embodiment of the present invention, the beryllium-containing phase is composed of a beryllium oxide shell surrounding a beryllium metal core. In yet a further embodiment of the present invention, the beryllium-containing phase is composed entirely of beryllium oxide. In yet further embodiments, the beryllium-containing phase can be composed of any combination of beryllium metal, a beryllium oxide shell surrounding a beryllium metal core, and a beryllium oxide. Notwithstanding the type of beryllium-containing solid material that constitutes the beryllium-containing phase, the beryllium-containing solid material can have an average particle size from about 10 nm to about 1 mm, with an average particle size from about 0.1 mm to about 0.5 nm being preferred in some embodiments of the present invention.

In some embodiments, Composite Structure 1 can be used as a core material in a fission reactor to slow neutrons that are present in the reactor through elastic collision.

Composite Structure 2:

In some embodiments of the present invention, the entrained phase that is contained within the magnesium oxide-containing matrix is a metal hydride-containing phase, wherein the metal of the metal hydride-containing phase is selected from yttrium (Y), zirconium (Zr), lithium (Li) and mixtures thereof; such a composite structure is referred to herein as Composite Structure 2. Metal hydrides of Y, Zr and Li have a range of uses including those that take advantage of their ability to favorably interact with neutrons as structural components of certain nuclear fission reactors and in various application utilizing neutron beams. However, a limitation of monolithic metal hydrides in elevated temperature and/or irradiation environments is the mobility, bulk-redistribution, and loss of hydrogen from the metal hydride embodiment. Given the high-temperature performance and oxygen resistance of MgO, along with its favorably low neutron cross section and resistance to the damaging effect of neutron irradiation, composite structures of magnesia matrix with these entrained hydrides are attractive. In this form and with fully dense magnesia matrices, hydrogen diffusion, loss, and decomposition of the hydride may be mitigated in high-temperature and/or irradiation environments.

The metal hydrides of Y, Zr and Li have well understood thermal decomposition behavior resulting in a temperature processing window inconsistent with standard MgO processing. As example, the plateau pressure window which designates the partial pressure of hydrogen over the two-condensed-phase region containing a mixture of hydride and metal phase is 700-800° C. (LiH), 550-900° C. (ZrH₂) and 900-1350° C. (YH₂).

In Composite Structure 2 of the present invention in which a metal hydride-containing phase is contained within the magnesium oxide-containing matrix, the metal hydride-containing phase can present in the magnesium oxide-containing matrix in an amount from about 10 volume % to about 50 volume %, with an amount from 15 volume % to about 40 volume % being more preferred. In some embodiments, the metal hydride-containing phase is distributed randomly in the magnesium oxide-containing matrix. In yet other embodiments, the metal hydride-containing phase is distributed in an ordered manner in the magnesium oxide-containing matrix.

The metal hydride-containing phase of Composite Structure 2 of the present invention is composed of a metal hydride-containing solid material that typically has a shape of a nodule. For example, the metal hydride-containing solid material can include lithium hydride, zirconium hydride and/or yttrium hydride. Notwithstanding the type of metal hydride-containing solid material that constitutes the metal hydride-containing phase, the metal hydride-containing solid material can have an average particle size from about 100 nm to about 100,000 nm, with an average particle size from about 1,000 nm to about 50,000 nm being preferred in some embodiments of the present invention.

In some embodiments, Composite Structure 2 can be used as a core structural component of a fission reactor. In such embodiments, Composite Structure 2 slows neutrons that are present in the reactor through elastic collision with the composite structure.

Composite Structure 3:

Various types of nuclear (i.e., fissile) fuel are known. The most common type is the monolithic ceramic of urania. Another known type of nuclear fuel is a metal matrix fuel with is either alloyed or has a continuum of fissile materials such as the metals, oxides, carbides, or nitrides of uranium, plutonium, or thorium. A yet further type of nuclear fuel is microencapsulated nuclear fuel which is a relatively small, engineered fuel structure, typically made of a fissile nucleus surrounded by a number of thin and functional ceramic layers. The two most common examples are the bi-structural isotropic (BISO) fuel and the tri-structural isotropic (TRISO) fuel. In the case of BISOs, there is a fissile ceramic core typically surrounded sequentially by low density graphite (i.e., graphite having a density of approximately 1 g/cc), and high-density graphite (i.e., graphite having a density of approximately 1.9 g/cc). In the case of TRISO, the fissile ceramic core is typically surrounded by low density graphite (i.e., graphite having a density of approximately 1 g/cc), a high-density graphite, a silicon carbide layer, and another high-density graphite layer. This microencapsulated nuclear fuel has an average particle size on the order of from about 0.5 mm to about 1.1 mm. In its final fuel form, an array of these microencapsulations are compacted into larger bodies whereby the host matrix containing the fuel is historically graphite, and in the other known embodiment silicon carbide.

As magnesia is of lower parasitic neutron scavenging and superior in neutron moderation as compared to silicon carbide and has superior resistance to radiation damage than graphite, composite structures including a microencapsulated nuclear fuel (i.e., BISO or TRISO) contained within a magnesium oxide-containing matrix having a density of greater than 95% is of interest. In such composite structure the microencapsulated nuclear fuel represents the second phase that is entrained within the magnesium oxide-containing matrix. Of importance is that the microencapsulated nuclear fuel, which is relatively fragile and in service must have a very low defect fraction (much less than 0.1%), must be processed such that the fragile layered ceramic shells remaining undisturbed.

In some embodiments of the present invention, and when the entrained phase that is contained within the magnesium oxide-containing matrix is composed of a microencapsulated nuclear (i.e., BISO or TRISO) fuel is a random or ordered distribution of spheroids within the matrix. These nominally spherical fuel kernels can have an average diameter of from about 0.5 mm to about 1.1 mm.

In Composite Structure 3 of the present invention in which microencapsulated nuclear fuel is contained within the magnesium oxide-containing matrix, the microencapsulated nuclear fuel can present in the magnesium oxide-containing matrix in an amount from about 10 volume % to about 50 volume %, with an amount from 15 volume % to about 40 volume % being more preferred. In some embodiments, the microencapsulated nuclear fuel is distributed randomly in the magnesium oxide-containing matrix. In yet other embodiments, the microencapsulated nuclear fuel is distributed in an ordered manner in the magnesium oxide-containing matrix.

In some embodiments of the present invention, Composite Structure 3 can also include a beryllium-containing phase and/or a metal hydride-containing phase also entrained within the magnesium oxide-containing matrix. In such an embodiment, the beryllium-containing phase and/or a metal hydride-containing phase can be present in an amount from about 10 volume % to about 50 volume %, with an amount from 15 volume % to about 40 volume % being more preferred.

In some embodiments, Composite Structure 3 of the present invention can be used as a nuclear fuel in a fission reactor.

Method of Forming the Composite Structures of the Present Invention

Composite Structures 1, 2 and 3 described above can be formed utilizing a method that includes first forming a green body of a magnesium oxide-containing powder, a metal halide sintering aid, and an entrainment compound. The term “green body” is used herein to denote a consolidation of magnesium oxide-containing powder mixture through low-temperature pressing. That powder mixture may contain a magnesium oxide-containing powder, a metal halide sintering aid, and an entrainment compound.

In some embodiments of the present invention, the magnesium oxide-containing powder can have a single particle size distribution. In such an embodiment, the magnesium oxide-containing powder can have a single particle size having a mean diameter ranging from about 500 nm to about 10,000 nm. In other embodiments of the present invention, the magnesium oxide-containing powder can have a bimodal distribution of mean particle sizes including a first mean particle size and a second mean particle size, wherein the first mean particle size is less than the second mean particle size. In one example, the magnesium oxide-containing powder can have a first mean particle size from about 50 nm to about 100 nm and a second particle size from about 1,000 nm to about 5,000 nm. The magnesium oxide-containing powder that can be used in the present invention can, in some instances, have a purity of 99.9%. The magnesium oxide-containing powder can be a magnesia (MgO) powder or a MgAl₂O₄ powder. Prior to forming the green body, the magnesium oxide-containing powder can be dried (i.e., kiln-dried) in an inert gas environment (e.g., He, Ar and/or Ne) and at a temperature from about 100° C. to about 200° C.

The type of metal halide sintering aid that can be used in the present invention is selected such that the chosen metal halide sintering aid used to form the composite structure has a bulk or eutectic melting temperature that is substantially the same as the temperature at which dissociation or adverse reaction of the entrained phase takes begins. The term “substantially the same as” when used to compare the temperature of the sintering aid and the entrainment compound denotes that the melting temperature of the metal halide sintering aid is within about ±100° C. from the target processing temperature of the entrained phase. Sintering temperature is defined herein as the temperature in which a powder material coalesces into a solid or porous mass with liquefaction.

For sintering with an entrainment compound composed of a metal hydride, appropriate metal halide salts that can be used include lithium bromide, lithium fluoride, and lithium chloride. These metal halide salt sintering aids can also be used for sintering with the other entrainment compounds of the present invention.

The entrainment compound that can be used in the present invention can include a beryllium-containing compound, a metal hydride-containing compound wherein the metal of the metal hydride is lithium, zirconium and/or yttrium, a microencapsulated nuclear fuel and a mixture thereof. Illustrative examples of beryllium-containing compounds that can be used in the present invention include, but are not limited to, beryllium metal, beryllium oxide, or a mixture of the two. Illustrative examples of metal hydride compounds include YH₂₋ₓ, ZrH₂₋ₓ and LiH, where “−x” denotes a sub-stoichiometric composition and x ranges from 1.25-2.0. Illustrative examples of nuclear fuel that can be used in the present invention include, but are not limited to, BISO or TRISO as defined above.

The mixture of the magnesium oxide-containing powder, the metal halide sintering aid, and the entrainment compound that provides the green body, can be formed by adding, in any order, the magnesium oxide-containing powder, the metal halide sintering aid, and the entrainment compound to a mixer, such as for example, a bladeless dual-asymmetric-centrifugal mixer. Mixing may be performed during, and/or after each addition step. In one embodiment, the mixture that is used in forming the green body comprises first adding the magnesium oxide-containing powder to the mixer, followed by second adding the metal halide sintering aid to the mixer containing the magnesium oxide-containing powder and thereafter third adding the entrainment compound to the mixer containing both the magnesium oxide-containing powder and the sintering aid. In such an embodiment, mixing can be performed during and/or after each of the three addition steps. In some embodiments, such as, for example, when a nuclear fuel is used as the entrainment compound, a dispersant such as, for example, polyethyleneimine (PEI) can be added to the mixture. The mixture used in forming the green body can contain from 1 weight percent or less of the metal halide sintering aid, and from about 10 volume percent to about 50 volume percent of the entrainment compound, with the balance being the magnesium oxide-containing powder. When a dispersant is present in the mixture that provides the green body, the dispersant is present in amount from about 0.2 weight percent to about 1.1 weight percent.

In some embodiments, the mixture can be pressed at a pressure of about 100 MPa to about 200 MPa to provide the green body. In other embodiments, the mixture can be pressed at a pressure of about 50 MPa. The green body thus formed is then sintered to provide a composite structure in accordance with the present invention. The resultant composite structure contains a magnesium oxide-containing matrix having a density of greater than 95%, and an entrained phase including at least one of the entrainment compounds contained within the magnesium oxide-containing matrix. The resultant composite structure is substantially-free, or even devoid, of the metal halide sintering aid or its disassociation or reaction products, having volatilized from the system.

The sintering is performed utilizing an electrically-assisted sintering process. The electrically-assisted sintering process is typically, but not always, carried out under vacuum on the green body in the range of from about 10 MPa to about 50 MPa with initiation of sintering starting at a temperature from about 700° C. to about 1000° C. In the case of a beryllium compound with 1 weight percent metal halide sintering aid present, the MgO sintering is initiated at a starting temperature of somewhat less than 800° C. It is noted that the presence of the metal halide sintering aid reduces the sintering temperature required to form a composite structure as compared to a composite structure formed without the sintering aid. This aspect of the present invention will be discussed in further detail herein below.

In some embodiments of the present invention, and when a metal hydride-containing compound is used as the entrainment compound, the sintering is performed in the presence of a hydrogen-containing atmosphere. Illustrative hydrogen-containing atmospheres that can be used include forming gas (mixture of hydrogen and an inert gas mitigating issues of hydrogen flammability) or mono-molecular hydrogen. The presence of hydrogen effectively shifts the temperature-dissociation curve of the second phase metal-hydride to higher temperature, thereby improving the processing temperature window by increasing the effective decomposition temperature of the hydride.

In some embodiments, and when a microencapsulated nuclear fuel is used as the used as the entrainment compound, sintering is performed at a pressure of less than 10 MPa.

In some embodiments of the present invention, the method of forming the composite structures of the present invention may further include subjecting the composite structure to a post-processing anneal. When performed, the post-processing anneal is carried out at a temperature sufficient to removing minor amounts of residual metal halide or its disassociation products from the sintered green body to provide a composite structure that is substantially-free, or even devoid, of the metal halide sintering aid or its disassociation or reaction products. Typically, the post-processing anneal is carried out at a temperature from about 1000° C. from about 1 hour. Increased annealing temperature will have the same beneficial effect in removal of unwanted metal halide or metal halide by-products but may have deleterious effects on the entrained phase.

While the above provides a general methodology for forming composite structures in accordance with the present invention, the following examples provide more specific details concerning the methodology that can be used in forming a specific type, i.e., Composite 1, 2 or 3, composite structure.

### EXAMPLE 1

### Preparation Scheme for Composite Structure 1

As derived, the simplest form of a Composite Structure 1 a process with resulting near full density magnesia matrix is limited in processing temperature and time to avoid significant second phase deformation or reaction between beryllium with magnesia. This was achieved through manipulation of starting magnesia powder, use of a fugitive metal halide salt sintering aid, and rapid sintering through electrically-assisted sintering. To achieve required compact green density, a bimodal distribution of magnesia powder was used, ranging in near equal part 50-100 nm and 1000-5000 nm powder. Powder of >99.9% purity is optimal. Use of a single particle size is allowed, though the as-pressed green density may be reduced, and the final sintered magnesia matrix density is in the range of 95-97%.

The bi-modal magnesia power was kiln-dried in an inert gas environment at 150° C. and mixed using a bladeless dual-asymmetric-centrifugal mixer. A metal halide salt of melting temperature similar to the sintering temperature as defined by the limitations of the entrained phase was selected. For the sintering with an entrained phase of beryllium metal, appropriate salts include lithium-bromide, lithium-fluoride and lithium-chloride. One or more of these salts was included at a ratio of 1 weight percent total, or less, of salt in the bimodal-MgO/salt mixture into which beryllium metal nodules of up to 40 volume percent were added. The MgO/salt/Be metal dry mixture was then remixed using the dual-asymmetric-centrifugal mixer and pressed into a green-body at pressures in the range of 100-200 MPa.

Electrically-assisted sintering was then carried out under vacuum (<10 Pa) on the green body in the range of 10-50 MPa with initiation of sintering beginning at somewhat less than 800° C.

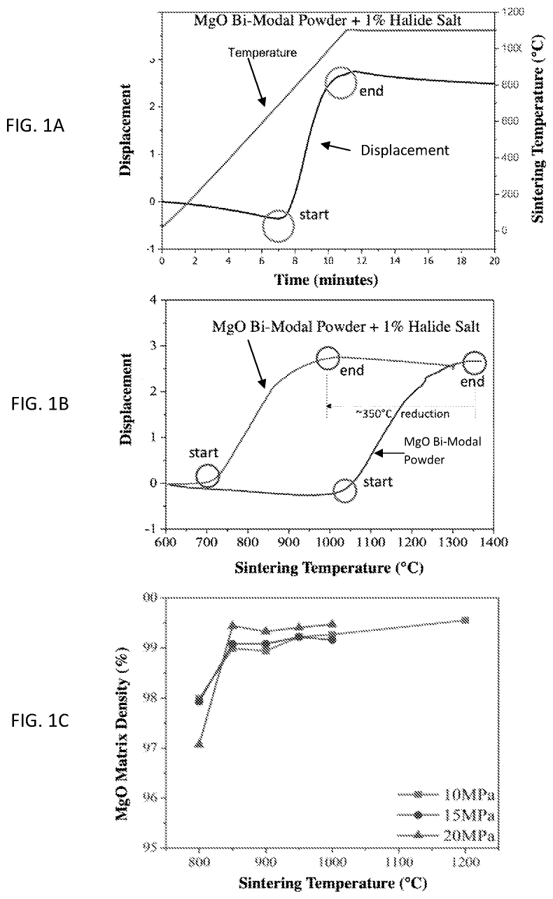

FIGS. 1A-1C provides sintering curves for MgO-1% Halide Salt/Beryllium Metal. Notably, FIG. 1A provides the time-displacement curves for the electrically-assisted sintering of the Composite Structure 1 compact. As seen from the increase in displacement of FIG. 1A, the sintering initiates at approximately 800° C. FIG. 1B provides the sintering contrast between pure MgO powder and 1% Halide Metal included powder, indicating an approximate 350° C. reduction in the lower temperature bound of the processing temperature window for this selection of magnesia powder, sintering aid, and application of electrically-assisted sintering. FIG. 1C provides a scan in density as a function of applied pressure and final sintering temperature indicating full density for the magnesia matrix occurs for all sintering conditions at or above 800° C. and near theoretical density occurs for sintering temperatures above 850° C. In all cases, a ten-minute hold time at maximum sintering temperature was applied.

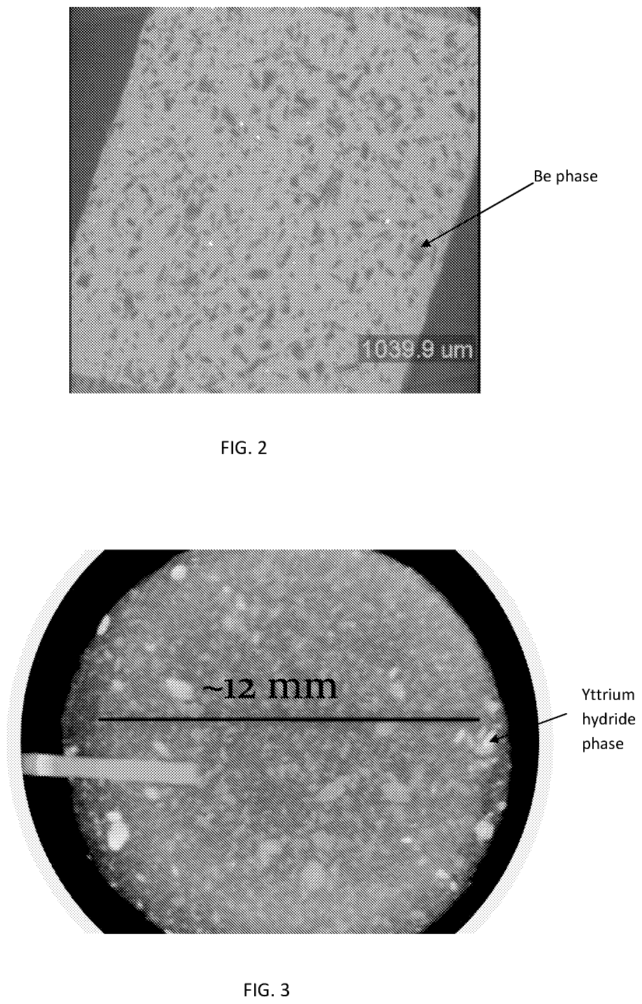

Composite Structure 1 can be readily fabricated from the above methodology in beryllium metal volume fractions of 10, 20, 30, and 40% depending on application requirements. FIG. 2 provides a tomographic image of the Composite Structure 1 indicating a range of entrained beryllium metal of similar size and size range to starting material. In FIG. 2, light grey areas are magnesia matrix, dark grey are entrained beryllium metal. Dependent on temperature, limited reaction of the beryllium metal with the magnesia matrix occurs producing an outer shell of BeO on the entrained phase. In the extreme case beryllium can be reacted partially or in its entirety to achieve an entrained phase of a continuum of BeO-to-Be metal ratios up to 100% BeO. Similarly, BeO nodules may be used as the starting entrained phase utilizing the same methodology. The metal halide is seen to largely leave the system due to processing, with any residual metal halide removed from composite following a post-processing anneal which was performed at 1000° C. for an hour.

### EXAMPLE 2

### Preparation Scheme for Composite Structure 2

As derived, Composite Structure 2 preparation utilized the magnesia matrix processing as described in Example 1, which as depicted in FIGS. 1A-1C, reducing the processing temperature for which fully dense magnesia was formed to a range overlapping the upper limit of metal hydride plateau pressures. Moreover, as derived, a hydrogen partial pressure was utilized in the electrically-assisted sintering chamber in which Composite Structure 2 was formed. Hydrogen atmosphere may be limited to the isothermal hold at maximum temperature. The hydrogen environment during sintering may be forming gas (mixture of hydrogen and an inert gas mitigating issues of hydrogen flammability) or mono-molecular hydrogen. The presence of hydrogen effectively shifts the temperature-dissociation curve of the second phase metal-hydride to higher temperature, thereby improving the composite structure processing temperature window.

As dictated by the application and processing limitations second-phase entrained metal hydride levels may exist in a continuum of volume fractions up to 50% of the final composite form. FIG. 3 provides an image of Composite Structure 2 with agglomerates of yttrium hydride (YH₂₋ₓ) of similar size to the starting hydride material and processed at a maximum isothermal hold temperature of 900° C. and utilizing a forming gas atmosphere within the sintering chamber. In FIG. 3, the light grey areas are the entrained yttrium hydride, and the dark grey is magnesia matrix. Of note is that the entrained hydride phase exists as discontinuous bodies entrained in the magnesia matrix. Interconnection of hydride phases through the composite body has been avoided.

### EXAMPLE 3

### Preparation Scheme for Composite Structure 3

The processing procedures for preparing Composite Structure 1 and Composite Structure 2 may be optimized to much reduce the applied pressure in all stages of processing. This may be accomplished through specific selection of starting magnesia powder distribution, type and amount of halide salt sintering aid, use of a dispersant such polyethyleneimine (PEI), and sintering atmosphere. Composite 3 is an example composite for which pressure applied during green forming and electrically-assisted sintering has been reduced from nominally 50 MPa during green forming and less than 10 MPa during sintering. This allows the entrainment of relatively fragile second phases within a fully dense or theoretically dense magnesia matrix. As example of a unique structure is the magnesia matrix/encapsulated fission fuel composite.

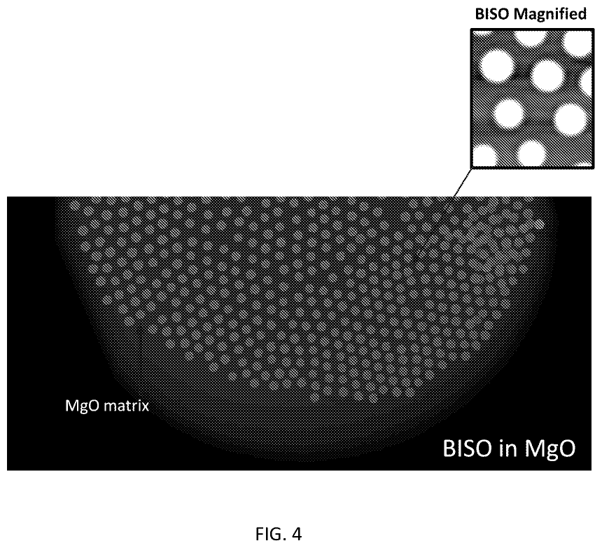

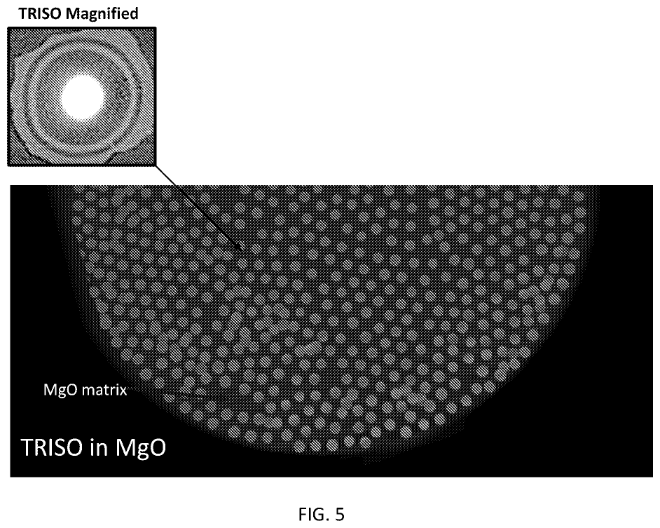

As derived, Composite 3 structures utilize the magnesia matrix processing as described for preparing Composite Structure 1 with a optimized bimodal distribution of magnesia powders and the use of a PEI dispersant to reduce the necessary green body pressure to less than 50 MPa. While remaining below 1% total metal halide salt addition inclusion, a fully dense magnesia matrix was realized at less than 10 MPa pressure applied during electrically-assisted sintering. FIG. 4 provides an x-ray tomography image of BISO in magnesia prepared in accordance with the present invention, while FIG. 5 provides an x-ray tomography image of TRISO in magnesia prepared in accordance with the present invention. Of note is that this process provides for an entrained population of microencapsulated fuels which are substantially free of defects as defined by the lack of fractured ceramic coatings.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. A composite structure comprising a beryllium-containing phase contained within a magnesium oxide-containing matrix having a density of greater than 95%.

2. The composite structure of claim 1, wherein the density of the magnesium oxide-containing matrix is greater than 99%.

3. The composite structure of claim 1, wherein the magnesium oxide-containing matrix is composed of MgO or MgAl₂O₄.

4. The composite structure of claim 1, wherein the beryllium-containing phase is present in the magnesium oxide-containing matrix in an amount from about 10 volume % to about 50 volume %.

5. The composite structure of claim 1, wherein the beryllium-containing phase is composed entirely of beryllium metal.

6. The composite structure of claim 1, wherein the beryllium-containing phase is composed of a beryllium oxide shell surrounding a beryllium metal core.

7. The composite structure of claim 1, wherein the beryllium-containing phase is composed entirely of beryllium oxide.

8. A composite structure comprising a metal hydride-containing phase contained within a magnesium oxide-containing matrix having a density of greater than 95%, wherein the metal of the metal hydride-containing phase is selected from yttrium, zirconium, lithium and mixtures thereof.

9. The composite structure of claim 8, wherein the density of the magnesium oxide-containing matrix is greater than 99%.

10. The composite structure of claim 8, wherein the magnesium oxide-containing matrix is composed of MgO or MgAl₂O₄.

11. The composite structure of claim 8, wherein the metal hydride-containing phase is present in the magnesium oxide-containing matrix in an amount from about 10 volume % to about 50 volume %.

12. A composite structure comprising a microencapsulated nuclear fuel contained within a magnesium oxide-containing matrix having a density of greater than 95%.

13. The composite structure of claim 12, wherein the density of the magnesium oxide-containing matrix is greater than 99%.

14. The composite structure of claim 12, wherein the magnesium oxide-containing matrix is composed of MgO or MgAl₂O₄.

15. The composite structure of claim 12, wherein the microencapsulated nuclear fuel is composed of a bi-structural isotropic fuel or a tri-structural isotropic fuel.

16. The composite structure of claim 12, further comprising at least one of a beryllium-containing phase and a metal hydride-containing phase contained within the magnesium oxide-containing matrix.

17. The composite structure of claim 12, wherein the microencapsulated nuclear fuel is present in the magnesium oxide-containing matrix in an amount from about 10 volume % to about 50 volume %.

18. A fission reactor comprising core structural components as a composite of a beryllium-containing phase or a metal hydride-containing phase contained within a magnesium oxide-containing matrix having a density of greater than 95%, wherein the metal of the metal hydride is selected from yttrium, zirconium, lithium and mixtures thereof, and the composite slows neutrons that are present in the reactor through elastic collision with the composite.

19. A fission reactor comprising a nuclear fuel composed of a microencapsulated nuclear fuel entrained within a magnesium oxide-containing matrix having a density of greater than 95%.

20. A method comprising:
forming a green body of a magnesium oxide-containing powder, a metal halide sintering aid, and an entrainment compound selected from a beryllium-containing compound, a metal hydride-containing compound, wherein the metal of the metal-hydride compound is selected from yttrium, zirconium, lithium and mixtures thererof, a microencapsulated nuclear fuel and a mixture thereof; and
sintering the green body utilizing an electrically-assisted sintering process to provide a composite structure including an entrained phase including at least one of the entrainment compounds contained within a magnesium oxide-containing matrix having a density of greater than 95%, wherein the metal halide sintering aid has a bulk or eutectic melting temperature that is substantially the same as the sintering temperature of the entrainment compound.

21. The method of claim 20, wherein the forming of the green body comprises:
providing a mixture of the magnesium oxide-containing powder, the metal halide sintering aid, and the entrainment compound; and
pressing the mixture at a pressure of about 50 MPa.

22. The method of claim 20, further comprising subjecting the composite structure to a post-processing anneal, wherein the post-processing anneal is performed at a temperature sufficient to remove residual metal halide or metal halide by-products from the composite structure.

23. The method of claim 20, wherein the metal halide sintering aid is present in the green body in an amount of 1 weight percent or less.

24. The method of claim 20, wherein when the beryllium-containing compound is used as the entrainment compound, then the sintering is performed under vacuum.

25. The method of claim 20, wherein when the metal hydride-containing compound is used as the entrainment compound, then the sintering is performed in the presence of a hydrogen-containing atmosphere.

26. The method of claim 20, wherein when the microencapsulated nuclear fuel is used as the entrainment compound, then a dispersing aid is used in the forming of the green body, and the sintering is performed at a pressure of less than 10 MPa.
